(19) United States
(12) Patent Application Publication
(10) Pub. No.: US 2006/0261212 A1
(43) Pub. Date: Nov. 23, 2006

(54) Paper Planes

(75) Inventor: Linda Feliciano, Boston, MA (US)

Correspondence Address: Linda Feliciano, 96 Gainsborough St. #5, Boston, MA, 02115, US

(73) Assignee: Ms. Linda Feliciano, Boston, MA (US)

(21) Appl. No.: 10/908,690

(22) Filed: May 23, 2005

(51) Int. Cl. B64D 11/00

(52) U.S. Cl. 244/1 R

(57) ABSTRACT

This proposal is for a children's flight. This project, which I have named “Paper Planes,” will create flights geared towards families traveling with children. It is similar in concept to a family restaurant. It is intended to provide families with an atmosphere that will allow them to enjoy the flight and relax. As most child psychologists and caregivers will agree, keeping children entertained and comfortable is the key to keeping them happy. “Paper Planes” mission is to ensure the enjoyment of the entire family by doing the one thing most parents forget to do while traveling with children; keep them entertained. It is a family-oriented flights that include a re-design of aircraft structure, in-flight services and possibly safety measures.

Proposal—

This proposal is for a children's flight. This project, which I have named “Paper Planes,” will create flights geared towards families traveling with children. It is similar in concept to a family restaurant. It is intended to provide families with an atmosphere that will allow them to enjoy the flight and relax. As most child psychologists and caregivers will agree, keeping children entertained and comfortable is the key to keeping them happy. “Paper Planes” mission is to ensure the enjoyment of the entire family by doing the one thing most parents forget to do while traveling with children; keep them entertained.

Introduction—

As a frequent traveler I often find myself in the situation where I am on a flight several hours long. Due to the space limitation and the constraints of the plain it is easy to become irritable. Although I do not have any children, I do love and enjoy kids very much. However, almost all of us have been in a plane with an unruly kid or a screaming child. We may intend to be tolerant and compassionate; however it is very difficult not to feel uncomfortable or inconvenienced. Especially, if you are traveling on business and trying to prepare for work or hoping to doze off for a while during the flight. And, I believe it is also uncomfortable for the parents who may feel they are imposing on other paying customers.

After searching through the Internet I did not find any information that could provide some background or opinion basis for my idea. However, I have enough traveling friends and co-workers to know that “children in flight” is a common concern. I've been joking around for years, saying that I will create an airline for kids and become a millionaire. Recently, I decided that it is an idea worth pursuing. And, after reading about the innovative and unexpected origins of jet Blue, I decided that you would be the best audience to present my idea to.

As I started developing and organizing my thoughts my focus shifted. The idea originated as a way to allow business travelers to fly without the intrusion of children. However, it slowly became more about providing families traveling with children with an environment tailored around their needs. An environment, where they can feel comfortable, entertained, safe and relaxed.

Research—

Survey current business customers to determine:

What percentage of traveler's would be willing to purchase a higher-price ticket if they were guaranteed no children in the flight?

How much more would they be willing to pay on average?

Analyze flight routes to determine highest volume of business travelers coinciding with high volume of children traveling. This can provide the best routes in which to launch the pilot program.

Survey parents and children to determine:

What features would be helpful from a functional as well as an entertainment perspective?

How much would parents be willing to pay for a “children's flight?”

Ideas for naming the pilot program.

Determine what type of plane to choose as model.

Determine the cost of re-designing the plane structure. How many seats must be removed to accommodate new travel space?

Execute cost analysis of “lost” revenue as determined by average seating price of places removed.

Analyze data and determine how to price tickets to achieve a net gain per flight to offset revenue loss to decreased capacity (i.e. less seating.)

Investigate security measures necessary to accommodate the space plan and execute cost analysis.

Explore marketing options, such as a possible partnership with companies that sell or distribute products for children.

Features—

The “Quiet Room” is a sound-proof space where parents can go if their children are being loud. It could be designed as multiple, restroom-sized booths or as a larger “room” to fit multiple travelers.

The “Play Pool” is a play area where children can play with others. It could be designed as an open play pen or an enclosed room. It could be equipped with fully-padded walls for protection. It can include a small car race track, Barbie doll house, and other toys and play items.

The “Game Keeper” is small closet or storage area to hold board games, game-boys, cards, coloring books, educational games, walkman and CD players and other entertainment for all ages.

Play Stations can be located at specific common locations throughout the plane.

Televisions can have a choice of family movies, cartoons, or TV shows such as Nickelodeon.

Children's meals should be small and fun items for kids such as chicken nuggets, fish sticks, macaroni & cheese, cereal, Kool-Aid, chocolate milk, etc. Meals for adults and teenagers could be quick, and convenient such as sandwiches and snacks that will allow parents in particular to eat while monitoring their children. A healthier version of meals should also be available for vegetarian, kosher or health-conscious families. And, could include items like animal-shaped carrots.

Flight attendants can be trained so there is at least one attendant per flight that can perform magic tricks, dress-up as a clown or create balloon animals to entertain the children.

Staff member with childcare training to help parents and help handle potential difficult situations.

Restrooms equipped with changing tables and other useful articles such as baby wipes, baby powder, etc.

Implementing the Pilot—

The first step of the pilot program would be creating a customer survey that will incorporate the questions presented in the research section. The simplest method of carrying this out would be to design a one-page survey that would be divided in two sections. One section targeted to business customers and another to customers flying with families. The survey instructions will indicate to complete only the one section of the survey that pertains to the customer's current flight.

The surveys can be loaded into the back pocket of the seats during cleaning and loading of the aircraft. As an incentive frequent flyer miles can be offered to those customers that complete the survey.

The rest of the information regarding flights and customer travel patterns can be easily obtained from the airlines booking and reservation system. Other information such as safety measures, aircraft re-design and marketing options should also be explored at this level to develop a complete cost-analysis.

Based on the information gathered, the development stage of the pilot can begin. This will include the selection of the plan based on cost-analysis data and re-design possibilities. As the plan is being restructured, negotiations can begin with the airline's main food provider and other vendors to accommodate the meal requirements. Negotiations can also be carried out with game and entertainment providers once the program is fully adopted. They could supply the airline with their products in exchange for free advertising in plane and terminals. However, during the pilot stage only a few games and toys will be required. They may be purchased—even used—at a discount from vendors.

Flight attendants should be trained in child care and entertainment. Or, crew could include an additional staff member entirely dedicated to this task.

The true marketing would be conducted through the airline's usual advertising channels. In addition, advertising materials such as flyers or brochures can be placed in each of the airline's aircrafts. A marketing partnership should also be pursued with family or children oriented businesses such as PlayStation and Nickelodeon TV channel (or ABC's children channels.) The airline can show exclusively Disney movies in-flight in exchange for Disney Entertainment Parks advertising the “Paper Planes” program. An agreement could be arranged with other entertainment vendors like Nickelodeon, PlayStation, Toys R Us, etc. Advertising can also be disseminated through children's books and comics, mother's magazines, etc.

It is important to include a customer satisfaction survey during pilot flights. This will allow parents and kids to rate their experience and suggest changes or improvements that may help enhance their future experience and increase their satisfaction and enjoyment. And, thus increase profitability by promoting the creation of long-term, loyal customers.

What is claimed is:

1. This proposal is for a children's airline or flight. The concept is flights geared towards families traveling with children or family-oriented flights that include a re-design of aircraft structure, in-flight services and possibly safety measures.
